(19) United States
(12) Patent Application Publication
(10) Pub. No.: US 2023/0005129 A1
(43) Pub. Date: Jan. 5, 2023

(54) METHOD FOR ASSESSING THE QUALITY OF VARNISHED WOOD SURFACES

(71) Applicant: LUFTHANSA TECHNIK AG, Hamburg (DE)

(72) Inventors: Mathias NOLTE, Tulsa, OK (US); Moritz REIFFERSCHEID, Basedow (DE)

(21) Appl. No.: 17/782,180

(22) PCT Filed: Nov. 24, 2020
(86) PCT No.: PCT/EP2020/083233

§ 371 Date: Jun. 3, 2022

(30) Foreign Application Priority Data
Dec. 6, 2019 (DE) 10 2019 133 364.4

(51) Int. Cl. G06T 7/00; G01N 21/88

(52) U.S. Cl. CPC G06T 7/0004; G01N 21/8851; G01N 2021/8427

(57) ABSTRACT

A method assess the quality of varnished wood surfaces. The method includes the following steps: a) creating a brightness map of the surface, b) creating a curvature map of the surface, c) ascertaining a cross-correlation of brightness map and curvature map, and d) evaluating the result of the cross-correlation to ascertain the proportion of the irregularities of the surface to be attributed to varnish flaws.

### CROSS REFERENCE TO RELATED APPLICATIONS

This application is a U.S. National Phase application under 35 U.S.C. § 371 of International Application No. PCT/EP2020/083233, filed on Nov. 24, 2020, and claims benefit to German Patent Application No. DE 10 2019 133 364.4, filed on Dec. 6, 2019. The International Application was published in German on Jun. 10, 2021 as WO 2021/110486 a1 under PCT Article 21(2).

### FIELD

The present disclosure relates to a method for assessing the quality of varnished wood surfaces.

### BACKGROUND

Wood enjoys great popularity as a construction material due to its elegant and natural appearance, for example, in furniture manufacturing, in vehicle interior fittings, and also in many other fields. The wood surface is often varnished to protect it, on the one hand, and to further improve the visual appearance, on the other hand, for example, by creating a “high-gloss finish”.

To assess the quality of varnished wood surfaces, the varnished surface may be subjected to an individual visual inspection. However, it is problematic here that the visual impression that an observer receives from a glossy varnished surface is always dependent on the incident light from the surroundings, which is reflected at the surface, due to which the observer sees an image of the surroundings projected on the surface. Moreover, the visual impression is strongly dependent on the viewing direction of the observer and also on the knowledge of the observer about the design and reflectivity of the inspected object. Individual visual inspections therefore result in subjective and thus poorly comparable results.

### SUMMARY

In an embodiment, the present disclosure provides a method that assess the quality of varnished wood surfaces. The method includes the following steps: a) creating a brightness map of the surface, b) creating a curvature map of the surface, c) ascertaining a cross-correlation of brightness map and curvature map, and d) evaluating the result of the cross-correlation to ascertain the proportion of the irregularities of the surface to be attributed to varnish flaws.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a: shows a brightness map used in the scope of the method according to the present disclosure, FIG. 1b: shows a brightness map generated by a low-pass filter, and FIG. 1c: shows a scaled brightness map;

FIG. 2: shows a curvature map used in the scope of the method according to the present disclosure; and

FIG. 3a: shows a Fourier transform of the scaled brightness map of FIG. 1(c), FIG. 3b: shows a Fourier transform of the curvature map of FIG. 2, FIG. 3c: shows a multiplication of the Fourier transforms from FIGS. 3a and 3b, FIG. 3d: shows a cross-correlation of the brightness map of FIG. 1c and the curvature map of FIG. 2.

### DETAILED DESCRIPTION

In an embodiment, the present disclosure provides an improved method for assessing the quality of varnished wood surfaces.

The method, according to an aspect of the present disclosure, for assessing the quality of varnished wood surfaces has the following steps:
a) creating a brightness map of the surface,
b) creating a curvature map of the surface,
c) ascertaining a cross-correlation of brightness map and curvature map,
d) evaluating the result of the cross-correlation to ascertain the component of the irregularities of the surface to be attributed to varnish flaws.

First, several terms used in the scope of the present disclosure will be explained.

A brightness map in the scope of the present disclosure refers to an assignment of brightness values to a plurality of points of the surface to be examined. The surface can be assigned for this purpose, for example, an x direction and a y direction, which is preferably oriented orthogonally thereto, wherein the surface is represented by a plurality of value pairs (x, y) and wherein a brightness value H(x, y) is assigned to each value pair. The points of the surface represented by the value pairs (x, y) preferably lie in a plane in which the observed surface is projected. The brightness values can be ascertained, for example, with the aid of a camera having a light-sensitive sensor. In particular, the observed surface section can be illuminated by a light source, wherein a brightness value H(x, y) is measured with the aid of the camera for each value pair (x, y) and used to create the brightness map. A corresponding pixel of the camera can be assigned to each value pair (x, y) of the surface.

The term curvature map refers to an assignment of curvature values K(x, y) to a plurality of points (x, y) of the surface to be examined. The curvature values are preferably the mean curvature of the surface at the respective point. The mean curvature is preferably given by the arithmetic mean of the two main curvatures in the respective point. The curvature map can be generated in a fundamentally known manner, for example, by means of strip deflectometry. The term “strip deflectometry” refers to a method in which a strip pattern is generated and oriented on a varnished surface to be examined. The reflection of the strip pattern on the varnished surface is acquired by a camera. Local irregularities present on the surface to be examined have the result that the strip pattern acquired by the camera is deformed in relation to the originally generated strip pattern. The curvature of the surface or the local alignment of the normal vectors, which are perpendicular to the surface at an observed point, can be calculated from the deformations (see, for example, “Li, Wansong; Bothe, Thorsten; von Kopylow, Christoph; Jüptner, Werner: High Resolution 3D Shape Measurement on specular surfaces by fringe reflection. In: Proceedings of SPIE Volume 5457, 2004, pages 411-422”).

The same camera is preferably used for the creation of the brightness map and for the creation of the curvature map.

The term cross-correlation is to be understood according to its typical mathematical meaning. The cross-correlation can in particular describe the correlation of the two functions H(x, y) and K(x, y) in dependence on a location shift (h, k) of the functions relative to one another in the x or y direction. The cross-correlation KK (h, k) of brightness map and curvature map can be ascertained, for example, for the case in which brightness map and curvature map are given by the two discrete location functions H(xᵢ, yⱼ) and K(xᵢ, yⱼ), according to:

$$KK ( h , k ) = α {\sum }_{i , j} H ( {x}_{i} , {y}_{j} ) \cdot K ( {x}_{i} + h , {y}_{j} + k )$$

The indices i, j denote the respective discrete x or y values here. The sums are formed, for the case in which brightness and curvature maps each have, for example, a number of n discrete x values and m discrete y values, by a double sum, in which the index i assumes the values 1 to n and the index j assumes the values 1 to m. The value α is a factor which enables scaling.

The curvature map permits a statement to be made about the curvatures present on the varnished surface and thus about existing irregularities. For this purpose, for example, the measured curvature values can be averaged over the entire observed surface and a standard deviation can be calculated. A large standard deviation results if large deviations from the mean curvature are present at many points of the surface. A large standard deviation is therefore fundamentally accompanied by a poor varnish quality.

However, it was recognized in the scope of the present disclosure that the curvature map and in particular the standard deviation do not permit a satisfactory quality assessment in many cases. In particular, it was recognized that the natural grain of wood surfaces often results in irregularities in the surface, which follow the course of the grain. This is because the grain of the wood is formed by pores which can contract or enlarge in the course of time. Trench formation or also bulging of the varnish can thus occur in the region of the pores. Such varnish flaws are referred to hereinafter as “varnish collapse”. It was furthermore recognized in the scope of the present disclosure that the visual impression is less strongly impaired by such a varnish collapse extending along the grain in comparison to other varnish flaws. Rather, a varnish collapse which extends along the grain is less noticeable and is perceived by an observer in many cases as less disturbing. A varnish collapse extending along a grain is therefore not included among the “varnish flaws” in the scope of the present disclosure. Varnish flaws in the scope of the present disclosure thus refer to irregularities and other faults in the varnished wood surface which do not represent a varnish collapse in the above-mentioned meaning.

Since the grain of the wood is recognizable on the brightness map as a brightness curve (the pores forming the grain are typically lighter or darker than the respective surroundings), it can be established in a simple manner in the scope of the present disclosure by the ascertainment of the cross-correlation of brightness map and curvature map whether the irregularities of the surface are to be attributed to the grain of the wood or not. The proportion of the irregularities of the surface which is to be attributed to varnish flaws can be ascertained in this manner. If, for example, a large cross-correlation is found, this means that a greater proportion of the irregularities is to be attributed to the grain.

The method according to the present disclosure thus enables, due to the consideration of the cross-correlation, a judgment as to whether measured irregularities are caused by the grain— and thus can have more of a tendency to be tolerated—or whether they are actually disturbing varnish flaws. Furthermore, the method according to the present disclosure can be carried out in an automated manner and is moreover independent of the subjective assessment of an observer. It can thus be ensured in a simple and cost-effective manner that repair measures are only performed when an objectively established varnish flaw actually exists.

In one preferred embodiment, the measured brightness distribution is scaled to create the brightness map. This has the advantage of better comparability between various surfaces. Moreover, it is possible to prevent differences in the illumination intensity from resulting in different results in the assessment of the varnish quality.

The scaling preferably comprises the following steps:
a) dividing the measured brightness distribution by a low-pass-filtered version of itself,
b) subtracting the mean value of the brightness from the result of step a.,
c) dividing the result of step b. by the standard deviation of the brightness.

Step a. is used here for the purpose of scaling locally differing brightnesses and contrasts, so that in particular those brightness maps which originate from surfaces of different types of wood are equalized with one another with respect to brightness and contrast. Moreover, the mean brightness is almost precisely at one due to the division according to step a. Due to the subtraction of the mean value and the division by the standard deviation, a brightness map is generated, the mean value of which is approximately zero and the standard deviation of which is approximately one, so that surfaces of various types of wood are optimally comparable to one another. Moreover, the following ascertainment of the cross-correlation is thus facilitated.

In one preferred embodiment, the ascertainment of a cross-correlation of brightness map and curvature map comprises the following steps:
a) carrying out a Fourier transform of the brightness map in the frequency space,
b) carrying out a Fourier transform of the curvature map in the frequency space,
c) multiplying the two Fourier transforms,
d) inverse Fourier transform of the result of the multiplication in step c. in the location space.

The inverse Fourier transform represents the cross-correlation in this case. It has been shown that the Fourier transforms of the brightness and curvature maps can be handled easily and the ascertainment of the cross-correlation is thus simplified. In particular, a so-called “fast” Fourier transform can be carried out.

In one preferred embodiment, it is provided that the evaluation of the result of the cross-correlation to ascertain the proportion of the irregularities of the surface to be attributed to varnish flaws is carried out by ascertaining the absolute value of the cross-correlation in its extreme point. The extreme point can be a maximum or a minimum, since the grain on the brightness map can appear either light or dark. Moreover, the varnish collapse in the region of a grain can be formed as explained above by a bulge or by a trench.

Since the brightness map, as explained above, is preferably already scaled, no further scaling of the cross-correlation is required for the mentioned evaluation. In particular, no scaling of the curvature distribution or the Fourier transform of the curvature distribution preferably takes place. This has the advantage that the absolute values of the cross-correlation in the extreme point enable an absolute statement about the extent of the varnish collapse caused by the grain, and thus a direct comparison can be performed for various observed varnished surfaces. However, it can be provided that the absolute value of the cross-correlation is divided by the geometric mean of the width and height of the curvature map of the observed surface region, to thus achieve scaling with respect to the image size (thus the size of the curvature map). If this adaptation to the image size is not carried out, the absolute value of the cross-correlation is dependent on this image size, which is undesirable for reasons of comparability.

In one advantageous embodiment, it can be provided that a standard deviation of the curvature map is ascertained, wherein the standard deviation is used as a further indicator for the assessment of the varnish quality. It is preferably provided here that the curvature map is first filtered of the mean value. The mean value filtering is required in particular if the surface to be assessed has a globally curved shape, thus in particular is not formed by a planar surface. In this case, the curvature map naturally follows the global curvature profile of the surface. The mean value-filtered curvature map can be obtained, for example, in that a low-pass-filtered version of the curvature map is ascertained and subtracted from the curvature map. Low-frequency curvature changes caused by the global shape of the examined surface are removed from the curvature map in this way (thus are no longer present in the mean value-filtered curvature map) and only the higher-frequency curvature changes to be attributed to varnish irregularities remain. A large standard deviation of the mean value-filtered curvature map is typically an indicator of a poor varnish quality.

Furthermore, in one preferred embodiment, a curvature threshold value can be defined and the number and/or the proportion of the points of the curvature map can be ascertained which exceed the curvature threshold value, wherein the number and/or the proportion of the points of the curvature map exceeding the curvature threshold value is used as a further indicator for the assessment of the varnish quality. If the measured curvature at a point of the curvature map exceeds the threshold value, a varnish flaw can be presumed. The number of the points exceeding the threshold value is thus also an informative indicator for the varnish quality. The ascertainment of the number and/or the proportion of the points exceeding the threshold value is preferably carried out on a mean value-filtered curvature map. It is also possible here to prevent the global curvature profile of a surface to be examined from exerting an influence on the evaluation.

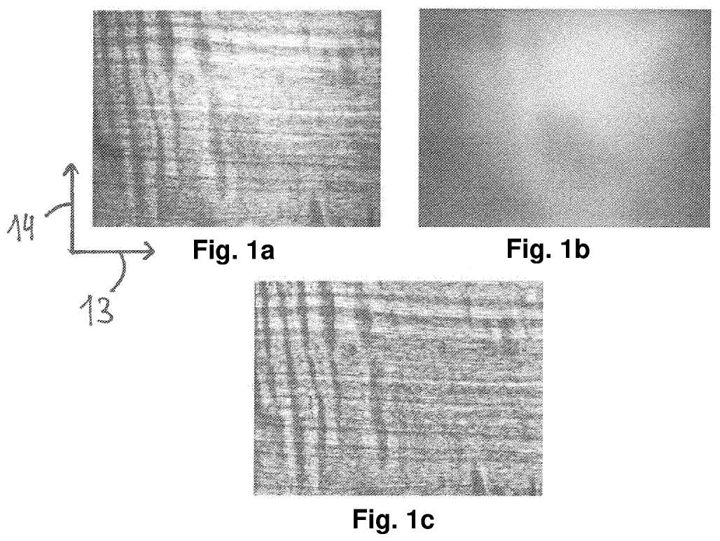

FIG. 1 shows multiple brightness maps used in the scope of the method according to an aspect of the present disclosure of a section to be examined of a varnished wood surface. The brightness maps are each formed as grayscale diagrams and have an extension in the x direction 13 and an extension in the y direction 14. The brightness maps have a plurality of pixels, wherein one grayscale value is assigned to each pixel, which represents the respective brightness.

To generate the brightness map shown in FIG. 1(a), the surface section represented by the brightness map was illuminated by a light source and acquired by a camera.

FIG. 1(b) shows a low-pass-filtered version of the brightness map shown in FIG. 1(a). Brightness changes at high frequency are filtered out by the low-pass filter, so that the brightness changes in FIG. 1(b) significantly slower in comparison to FIG. 1(a) if one “tracks” the respective map along an imaginary line.

FIG. 1(c) shows a brightness map in which the respective brightness results by way of a division of the brightness distribution shown in FIG. 1(a) by the brightness distribution shown in FIG. 1(b). This means that for each pixel given by a value pair (x, y), a quotient is formed from the respective brightness values. Due to this scaling, the brightness maps of various types of wood are equalized to one another with respect to their contrast and their brightness, so that better comparability exists.

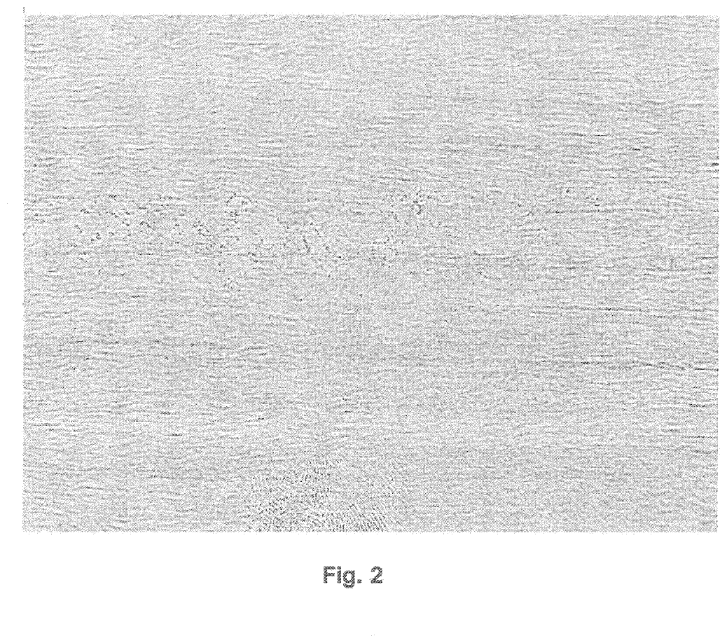

FIG. 2 shows a curvature map of the observed section of the varnished wood surface obtained by means of strip deflectometry. The curvature map is also a grayscale diagram, in which the respective grayscale value represents the curvature at the respective pixel. To generate the curvature map, a strip pattern was projected on the observed section and the reflection of the strip pattern was acquired by the camera. In a fundamentally known manner, a mean curvature was calculated on the basis of the deformed strip image acquired by the camera for each pixel (x, y), which is represented in FIG. 2 by a grayscale value. The number of the pixels of the curvature map corresponds to the number of the pixels (x, y) of the brightness map, moreover, the same section of the varnished wood surface is observed to create brightness map and curvature map.

In contrast to the brightness map, the curvature map is not scaled. In the later evaluation of the cross-correlation, this enables a statement about the absolute extent of the varnish collapse extending along a grain and thus a direct comparison between various varnished wood surfaces.

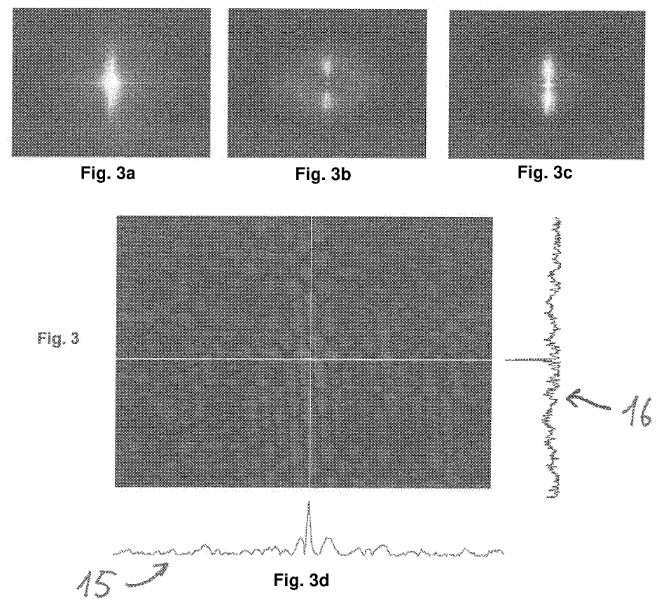

FIG. 3(a) shows the Fourier transform of the scaled brightness map of FIG. 1(c). The extent of the respective frequencies is shown in FIG. 1(c) by a grayscale value of the respective pixel. FIG. 3(b) shows a Fourier transform of the curvature map of FIG. 2. The extent of the respective frequencies is also shown in FIG. 3(b) by a grayscale value of the respective pixel. FIG. 3(c) shows a multiplication of the Fourier transforms of FIGS. 3(a) and 3(b).

Finally, FIG. 3(d) shows a grayscale diagram of an inverse Fourier transform of the multiplication of the Fourier transform shown in FIG. 3(c). The inverse Fourier transform of FIG. 3(d) represents the cross-correlation of the brightness map of FIG. 1(c) and the curvature map of FIG. 2, wherein in addition scaling with respect to the height and width of the observed image has taken place.

The obtained absolute value of the cross-correlation for various location shifts in the x and y directions is represented in FIG. 3(d) by a grayscale value of the respective pixel. Below the grayscale diagram of FIG. 3(d), a graph 15 is shown, which shows the cross-correlation as a function of the shift in the x direction, wherein the shift in the y direction is set to zero. To the right of the grayscale diagram of FIG. 3(d), a graph 16 is shown, which shows the cross-correlation as a function of the shift in the y direction, wherein the shift in the x direction is set to zero. The location of the two graphs in the grayscale diagram is indicated by a horizontal line or by a vertical line, respectively.

On the basis of the graphs 15 and 16, a maximum of the cross-correlation at a shift of (0, 0) can be seen clearly. On the basis of the absolute value of the cross-correlation in the maximum (0, 0), a statement can be made about which proportion of the irregularities ascertained by the curvature map is to be attributed to disturbing varnish flaws (scratches, varnished faults), and which proportion is to be attributed to the existing grain. In this way, the evaluation can be carried out in an automated and objective manner.

In addition to the cross-correlation ascertained as described above, further measured values can be used to assess the varnish quality. In particular, the standard deviation of the curvature can be used as a measured value on the basis of the curvature map. Moreover, a further measured value can be defined, which results from the number of those pixels, the curvature of which exceeds a defined curvature threshold value. For the ascertainment of the above-mentioned measured values, the curvature map is preferably, as explained above, filtered of the mean value, to avoid an undesired influence of the global curvature of the surface to be examined on the measured values.

The measured values can be assigned a weighting, wherein a global measured value can be calculated on the basis of the measured values in consideration of the respective weighting. The method according to the present disclosure in this way enables an objective assessment, which can be automated, of the quality of varnished wood surfaces.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for assessing the quality of varnished wood surfaces, the method comprising the following steps:
a) creating a brightness map of the surface,
b) creating a curvature map of the surface,
c) ascertaining a cross-correlation of brightness map and curvature map,
d) evaluating the result of the cross-correlation to ascertain the proportion of the irregularities of the surface to be attributed to varnish flaws.

2. The method as claimed in claim 1, wherein the measured brightness distribution is scaled to create the brightness map.

3. The method as claimed in claim 2, wherein the scaling comprises the following steps:
dividing the measured brightness distribution by a low-pass-filtered version of itself,
subtracting the mean value of the brightness from the result of step a.,
dividing the result of step b. by the standard deviation of the brightness.

4. The method as claimed in claim 1, wherein the creation of a curvature map of the surface is carried out by strip deflectometry.

5. The method as claimed in claim 1, wherein carrying out a cross-correlation of brightness map and curvature map comprises the following steps:
carrying out a Fourier transform of the brightness map in the frequency space,
carrying out a Fourier transform of the curvature map in the frequency space,
multiplying the two Fourier transforms,
inverse Fourier transform of the result of the multiplication in step c. in the location space.

6. The method as claimed in claim 1, wherein the evaluation of the result of the cross-correlation to ascertain the proportion of the irregularities of the surface to be attributed to varnish flaws is carried out by ascertaining the absolute value of the cross-correlation in its extreme point.

7. The method as claimed in claim 1, in which a standard deviation of the curvature map is used as a further indicator for assessing the varnish quality.

8. The method as claimed in claim 1, in which a curvature threshold value is defined and the number and/or the proportion of the points of the curvature map which exceed the curvature threshold value is ascertained, wherein the number and/or the proportion of the points of the curvature map exceeding the curvature threshold value is used as a further indicator for assessing the varnish quality.

9. The method as claimed in claim 7, in which the ascertainment of the respective indicator is based on a mean value-filtered curvature map.
